(19) United States
(12) Patent Application Publication
(10) Pub. No.: US 2009/0073648 A1
(43) Pub. Date: Mar. 19, 2009

(54) DUST-PROOF, BEZEL-ALIGNING, SPRING-LOADED CONNECTOR COVER

(75) Inventors: Brett C. Ong, San Jose, CA (US); Timothy W. Olesiewicz, Dublin, CA (US); Christopher H. Frank, San Jose, CA (US)

Correspondence Address: OSHA LIANG L.L.P./SUN, TWO HOUSTON CENTER, 909 FANNIN, SUITE 3500, HOUSTON, TX, 77010, US

(73) Assignee: Sun Microsystems, Inc., Santa Clara, CA (US)

(21) Appl. No.: 11/853,530

(22) Filed: Sep. 11, 2007

(51) Int. Cl. G06F 1/16; A47B 81/00

(52) U.S. Cl. 361/679.33; 312/223.2

(57) ABSTRACT

A hard disk drive filler assembly has a hard disk drive bracket and a hard disk drive filler disposed in the hard disk drive bracket. The hard disk drive bracket has a front bezel and a bracket body attached to the back of the front bezel. The hard disk drive filler has a filler body attached to the bracket body of the hard disk drive bracket, a connector cover disposed behind the filler body and operable to be disposed over a connector on a server module or a computer server rack, and at least one spring disposed between the dust cover and the filler body.

### BACKGROUND OF INVENTION

1. Field of the Invention

The invention generally relates to a hard disk drive filler.

2. Background Art

FIG. 1 shows a typical computer server rack 10 with blade server modules 15 disposed therein. Each blade server module 15 generally has at least a hard disk drive bracket 20 with a hard disk drive disposed therein. In other cases, the hard disk drive bracket 20 may be disposed directly into the server rack without a blade server module 15. The hard disk drives have connectors which connect to corresponding connectors on the back of the computer server rack 10 or on the back of a blade server module 15. Often, however, there are more slots for hard disk drives in the blade server module 15 or in the computer server rack 10 than there are hard disk drives to fit those slots. In such cases, hard disk drive fillers are disposed in place of the hard disk drive, acting as place holders. The hard disk drive filler and the hard disk drive bracket are together referred to as a hard disk drive filler assembly. Because hard disk drive fillers are simply place holders, there are no connectors on the back of the hard disk drive fillers. Thus, the connectors on the back of the computer server rack 10 or on the back of a blade server module 15 that are behind a hard disk drive filler are left empty.

### SUMMARY OF INVENTION

In one or more embodiments of the present invention, a hard disk drive filler comprises a filler body operable to be attached to a hard disk drive bracket; a connector cover disposed behind the filler body and operable to be disposed over a connector on a server module or a computer server rack, and at least one spring disposed between the dust cover and the filler body.

In one or more embodiments of the present invention, a hard disk drive filler assembly comprises a hard disk drive bracket and a hard disk drive filler disposed in the hard disk drive bracket. The hard disk drive bracket comprises a front bezel and a bracket body attached to the back of the front bezel. The hard disk drive filler comprises a filler body attached to the bracket body of the hard disk drive bracket, a connector cover disposed behind the filler body and operable to be disposed over a connector on a server module or a computer server rack, and at least one spring disposed between the dust cover and the filler body.

Other aspects and advantages of the invention will be apparent from the following description and the appended claims.

### BRIEF DESCRIPTION OF DRAWINGS

FIG. 1 shows a blade server rack with computer servers disposed therein.

FIG. 2 shows a back perspective view of a hard disk drive filler assembly according to one or more embodiments of the present invention.

FIG. 3 shows a back view of a hard disk drive filler assembly according to one or more embodiments of the present invention.

FIG. 4 shows a top view of a hard disk drive filler assembly according to one or more embodiments of the present invention.

FIG. 5 shows a bottom view of a hard disk drive filler assembly according to one or more embodiments of the present invention.

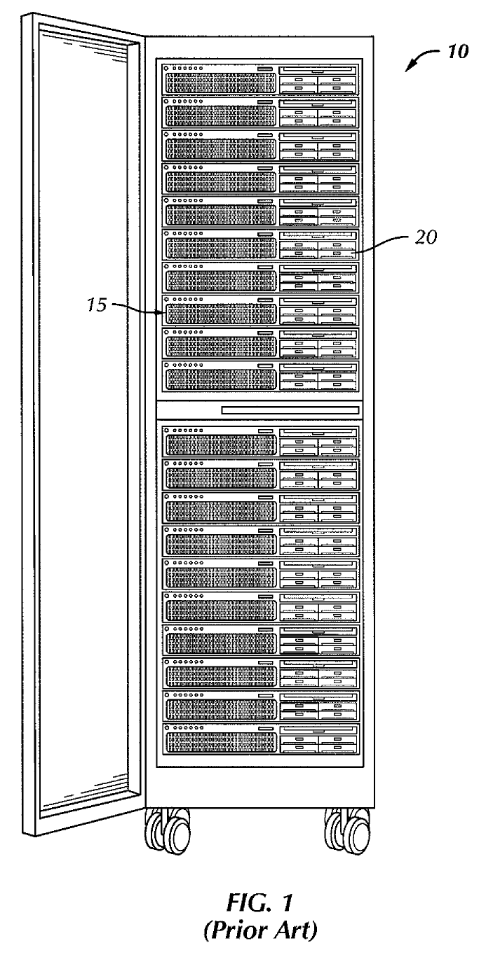

### DETAILED DESCRIPTION

Exemplary embodiments of the invention will be described with reference to the accompanying figures. Like items in the figures are shown with the same reference numbers.

In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

Embodiments of the invention relate to a hard disk drive filler assembly. More specifically, one or more embodiments of the invention relate to hard disk drive filler assembly having a hard disk drive filler with a spring-loaded connector cover.

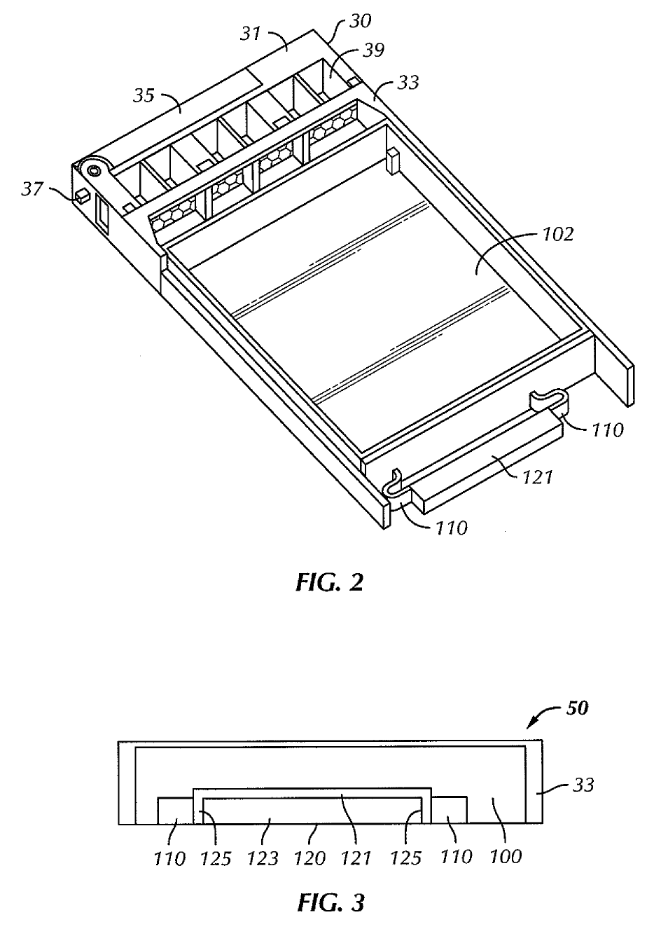

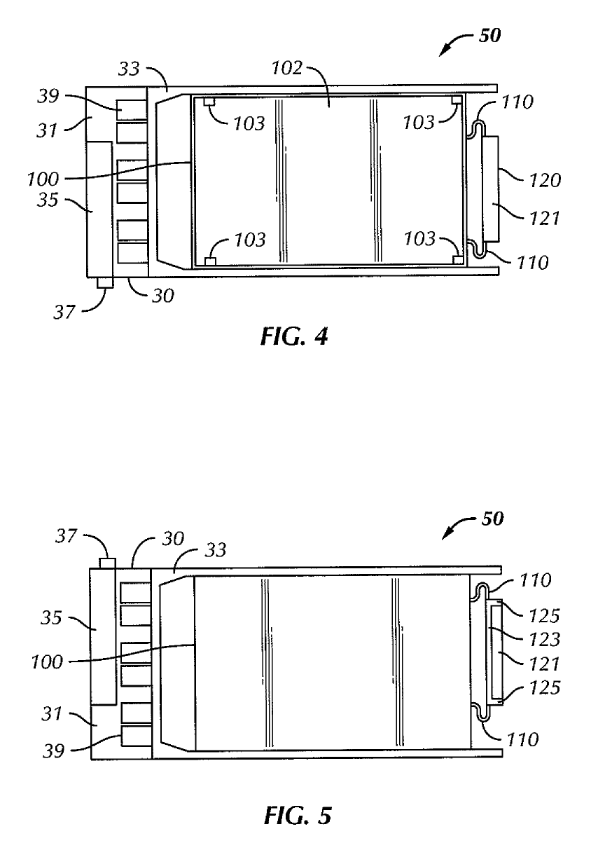

FIG. 2 shows a back perspective view of a hard disk drive filler assembly 50 according to one or more embodiments of the present invention. FIG. 3 shows a back view of a hard disk drive filler assembly 50 according to one or more embodiments of the present invention. FIGS. 4 and 5 show top and bottom views of a hard disk drive filler assembly 50 according to one or more embodiments of the present invention. The hard disk drive filler assembly 50 consists of the hard disk drive bracket 30 with the hard disk drive filler 100 disposed therein.

The hard disk drive bracket 30 consists of a bracket body 33 attached to the back of a front bezel 31. The front bezel includes EMI shield fingers 39, latch door 35, and latch 37. When the hard disk drive filler assembly 50 is disposed inside a server module or a computer server rack, the latch 37 secures the hard disk drive filler assembly 50 by latching onto an inside surface of the server module or the computer server rack. When a release button disposed on the front surface of the front bezel 31 is pressed, the latch door 35 swings outward, and the latch 37, which is part of the latch door 35, swings inward and the hard disk drive bracket 30 is disengaged from the server module or the computer server rack. Although a functional hard disk drive bracket 30 is described herein, a dummy hard disk drive bracket could also be disposed in place of the functional hard disk drive bracket 30, in which case certain features of the hard disk drive bracket 30, such as the EMI shield fingers 39, could be omitted.

The hard disk drive filler 100 is disposed within the bracket body 33 of the hard disk drive bracket 30. The hard disk drive filler 100 consists of a filler body 102 and a spring-loaded connector cover 101. The hard disk drive filler 100 acts as a place holder, and the filler body 102 can provide structural support. The hard disk drive filler 100 is attached to the bracket body 33, for example, by screwing the sides of the filler body 102 to the inside surfaces of the bracket body 33 using screws 103.

The hard disk drive filler 100 could also be attached to the inside surfaces of the bracket body 33 by a sliding engagement, latches, or any other removable attachment means known in the art. Further, if a dummy hard disk drive bracket is used in place of the functional hard disk drive bracket 30, the hard disk drive filler 100 could be permanently attached to the dummy hard disk drive bracket, or could also be made integrally with the dummy hard disk drive bracket.

The spring-loaded connector cover 101 is disposed on the back of the filler body 102. The spring-loaded connector cover 101 includes a cover 120 attached to the back surface of the filler body 102 by springs 110. In one or more embodiments of the present invention, the cover 120 and springs 110 are made integrally as once piece with the filler body 102. Alternatively, the cover 120 could also be attached to the filler body 102 with a separate spring 110. In one or more embodiments of the present invention, the cover 120 is four-sided, with a top wall 121, front wall 123, and a pair of side walls 125. In one or more embodiments of the present invention, the cover 120 is three-sided, with just a front wall 123 and a pair of side walls 125. In one or more embodiments of the present invention, the springs 110 are attached to the side walls 125 of the cover 120. Alternatively, the springs 110 could also be attached to the front wall 123, top wall 121, or a combination of any of the four walls.

When the hard disk drive filler assembly 50 is disposed in the server module or the computer server rack, the cover 120 directly engages over the connectors on the server module or the computer server rack. In one or more embodiments of the present invention, advantageously, the cover 120 ensures a constant seal against the connectors, improving environmental protection of the connectors, which are exposed without a functional hard disk drive plugged therein. This is especially important considering the sensitivity of the connectors to dust contamination. The spring-loaded connector cover can prevent dust from entering the connector, because the cover 120 shields the connectors.

In one or more embodiments of the present invention, advantageously, the spring 110 provides engagement feedback for the user when the hard disk drive filler assembly 50 is installed into the server module or the computer server rack. Thus, the user can know when the hard disk drive filler assembly 50 is fully engaged. In one or more embodiments of the present invention, advantageously, when the hard disk drive filler assembly 50 is installed into the server module or the computer server rack, because the cover 120 abuts against the back wall thereof, the compressive force of the compressed springs 110 pushes the hard disk drive filler assembly 50 outwards, ensuring that the front bezels 31 are flush and aligned with one another. The structure of the hard disk drive filler 100 according to one or more embodiments of the present invention are simple, and are easy and inexpensive to manufacture. Further, the hard disk drive filler 100 can be easily implemented in existing hard disk drive bracket 30, lowering the cost of implementation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A hard disk drive filler comprising:
a filler body operable to be attached to a hard disk drive bracket;
a connector cover disposed behind the filler body and operable to be disposed over a connector on a server module or a computer server rack; and
at least one spring disposed between the dust cover and the filler body.

2. The hard disk drive filler of claim 1, wherein the connector cover and the at least one spring are made integrally as one piece with the filler body.

3. The hard disk drive filler of claim 1, wherein the connector cover, the at least one spring, and the filler body are separate parts.

4. The hard disk drive filler of claim 1, wherein the connector cover is four-sided, and comprises a top wall, front wall, and a pair of side walls.

5. The hard disk drive filler of claim 4, wherein the at least one spring is attached to at least one of the side walls of the connector cover.

6. The hard disk drive filler of claim 4, wherein the at least one spring is attached to the top wall of the connector cover.

7. The hard disk drive filler of claim 4, wherein the at least one spring is attached to the front wall of the connector cover.

8. A hard disk drive filler assembly comprising:
a hard disk drive bracket comprising:
a front bezel; and
a bracket body attached to the back of the front bezel; and
a hard disk drive filler disposed in the hard disk drive bracket, the hard disk drive filler comprising:
a filler body attached to the bracket body of the hard disk drive bracket;
a connector cover disposed behind the filler body and operable to be disposed over a connector on a server module or a computer server rack; and
at least one spring disposed between the dust cover and the filler body.

9. The hard disk drive filler assembly of claim 8, wherein the filler body is attached to a hard disk drive bracket by screws.

10. The hard disk drive filler assembly of claim 8, wherein the front bezel comprises:
EMI shield fingers disposed around the periphery of the front bezel;
a latch door disposed on the front of the front bezel and operable to swing open; and
a latch operable to unlatch from a server module or a computer server rack.

11. The hard disk drive filler assembly of claim 8, wherein the connector cover and the at least one spring are made integrally as once piece with the filler body.

12. The hard disk drive filler assembly of claim 8, wherein the connector cover, the at least one spring, and the filler body are separate parts.

13. The hard disk drive filler assembly of claim 8, wherein the connector cover is four-sided, and comprises a top wall, front wall, and a pair of side walls.

14. The hard disk drive filler assembly of claim 13, wherein the at least one spring is attached to at least one of the side walls of the connector cover.

15. The hard disk drive filler assembly of claim 13, wherein the at least one spring is attached to the top wall of the connector cover.

16. The hard disk drive filler assembly of claim 13, wherein the at least one spring is attached to the front wall of the connector cover.

17. The hard disk drive filler of claim 1, wherein the filler body is adapted to be disposed in an hard disk drive bracket that is capable of holding an operational hard disk drive.

18. The hard disk drive filler assembly of claim 8, wherein the filler body is adapted to be disposed in an hard disk drive bracket that is capable of holding an operational hard disk drive.
